(19) United States
(12) Patent Application Publication
(10) Pub. No.: US 2019/0054778 A1
(43) Pub. Date: Feb. 21, 2019

(54) COMBINATION FLAT-PROOF TIRE AND LOW FRICTION TIRE INSERT

(71) Applicant: Jeffrey P. Douglas, San Clemente, CA (US)

(72) Inventor: Jeffrey P. Douglas, San Clemente, CA (US)

(21) Appl. No.: 15/677,521

(22) Filed: Aug. 15, 2017

(51) Int. Cl. B60C 17/06; B60C 5/00

(52) U.S. Cl. CPC B60C 17/065; B60C 19/12; B60C 2017/063; B60C 5/002

(57) ABSTRACT

Disclosed is a combination flat-proof tire and low friction insert having particular application for use on a motorcycle. The insert is preferably manufactured from a resilient (e.g., closed cell foam) material. The insert fills the tire and is movable relative thereto. A low friction sleeve surrounds the insert so as to reduce both friction and heat at the interface of the insert and the tire to minimize the degradation and replacement of the insert. By way of example, the low friction sleeve is manufactured from a smooth textile material having a thickness of about 0.005 inches. In one embodiment, the insert is separated into a plurality of compressible segments aligned side-by-side one another around the tire. Relatively hard spacers are located between adjacent pairs of the insert segments to apply compressive forces to the insert segments in response to road conditions.

### BACKGROUND OF THE INVENTION

### 1. Field of the Invention

This invention relates to a flat-proof tire having particular application for use on a motorcycle wherein the interior of the tire is completely filled with an insert that is manufactured from a solid, resilient (e.g., closed cell foam) material. The tire insert is covered by a low friction (e.g., nylon) sleeve which minimizes friction and the heat that will be generated at the interface of the tire and the insert when the tire is subjected to road conditions and the insert moves within the tire.

### 2. Background Art

It is known to locate a solid insert within the interior of a flat-proof tire so as to provide the tire with run flat support and thereby enable the tire to continue to operate after sustaining a puncture wound. It is also known that as the insert repeatedly expands and contracts in response to the road conditions to which the tire is subjected, friction and heat are produced at the interface of the tire and the insert which causes the insert to wear and deteriorate over time. The degradation of the insert can negatively affect the tire's performance and/or require that the insert be frequently replaced.

One solution by which to reduce the generation of heat caused by friction has been to bond the insert directly to the inside of the tire to limit the ability of the insert to move relative to the tire. However, this technique requires a time consuming bonding step and makes removal of the insert complicated. Another solution to minimize heat and insert deterioration is to cover the insert with a powder or a lubricant to reduce friction caused by the insert rubbing against the tire. However, such a powder or lubricant can be rubbed off leaving potential hot spots over the surface of the insert lying adjacent the tire.

What would therefore be desirable is an improved combination flat-proof tire and low friction insert that is located inside a tire and adapted to reduce surface-to-surface friction between the insert and the tire so as to advantageously minimize the generation of heat and the degradation of the insert as a result of road conditions and movement of the insert within the tire.

### SUMMARY OF THE INVENTION

In general terms, an improved combination flat-proof tire and low friction tire insert are disclosed which is ideal for use on a motorcycle. The interior of the tire is completely filled with a donut-shaped insert that is manufactured from a resilient (e.g., closed cell foam) material and capable of moving relative to the tire. The insert is shaped to extend completely and continuously around the interior of the tire to provide the tire with run flat support and enable it to continue to operate with a puncture. The insert is surrounded by a low friction cover (i.e., a sleeve) that is preferably manufactured from a smooth textile (e.g., nylon) material. The low friction sleeve reduces the surface-to-surface friction that will be created at the interface between the insert and the tire as the insert expands and contracts in response to road conditions encountered during use. By virtue of the foregoing, less heat is generated at the interface of the insert and the tire whereby to slow the degradation of and the need to replace the insert. The preferred thickness of the low friction sleeve which surrounds the insert is at least 0.005 inches.

In an alternate embodiment for an improved combination flat-proof tire and low friction tire insert, the insert is formed from a plurality of resilient (e.g., closed cell foam) segments. The insert segments are arranged side-by-side one another so as to extend around the inside of the tire. A (e.g., plastic or rubber or foam) spacer is located between each successive pair of side-by-side aligned insert segments. The spacers and the resilient insert segments alternate with one another around the tire so that the insert segments are compressed and move independently of one another in response to road conditions. Depending upon the density and the hardness of the insert segments and the spacers, the tire can be customized so that the forces transmitted to the (e.g., motorcycle) rider are selectively controlled to change his feel of the road. A low friction (e.g., nylon) sleeve surrounds the insert to hold the insert segments and the spacers in their side-by-side alignment and reduce friction and the corresponding heat that is created at the interface of the insert and the tire as the insert segments contract and expand.

By way of a first modification, the size of the spacers which alternate with the resilient insert segments inside the low friction sleeve of the tire insert is chosen so that rectangular voids or air gaps are created between the tops of the spacers and the crown of the tire within which the insert is located. The particular size of the voids located above the spacers allows the rider's feel of the road through the tire to be selectively controlled.

By way of a second modification, a continuous plurality of resilient insert segments extend around the tire insert. In this case, a triangular (i.e., V-shaped) void or air gap is created at the interface of each pair of adjacent insert segments. The triangular voids are widest at their tops which lie below the crown of the tire within which the insert is located so that the rider's feel of the road through the tire can be selectively controlled depending upon the size of the voids.

### BRIEF DESCRIPTION OF THE DRAWINGS

FIG. 1 is a perspective partially broken away view of an improved combination flat-proof tire and low friction tire insert to be mounted on the rim of a wheel according to a first preferred embodiment of this invention;

FIG. 2 is a cross-section of the combination flat-proof tire and low friction tire insert taken along lines 2-2 of FIG. 1;

FIG. 3 is a partial cross-section of the low friction tire insert from the combination shown in FIG. 1;

FIG. 4 is a partial cross-section of a low friction tire insert for a flat-proof tire according to a second preferred embodiment of this invention;

FIG. 5 illustrates a first modification to the low friction tire insert shown in FIG. 4; and

FIG. 6 illustrates another modification of the low friction tire insert shown in FIG. 4.

### DESCRIPTION OF THE PREFERRED EMBODIMENT

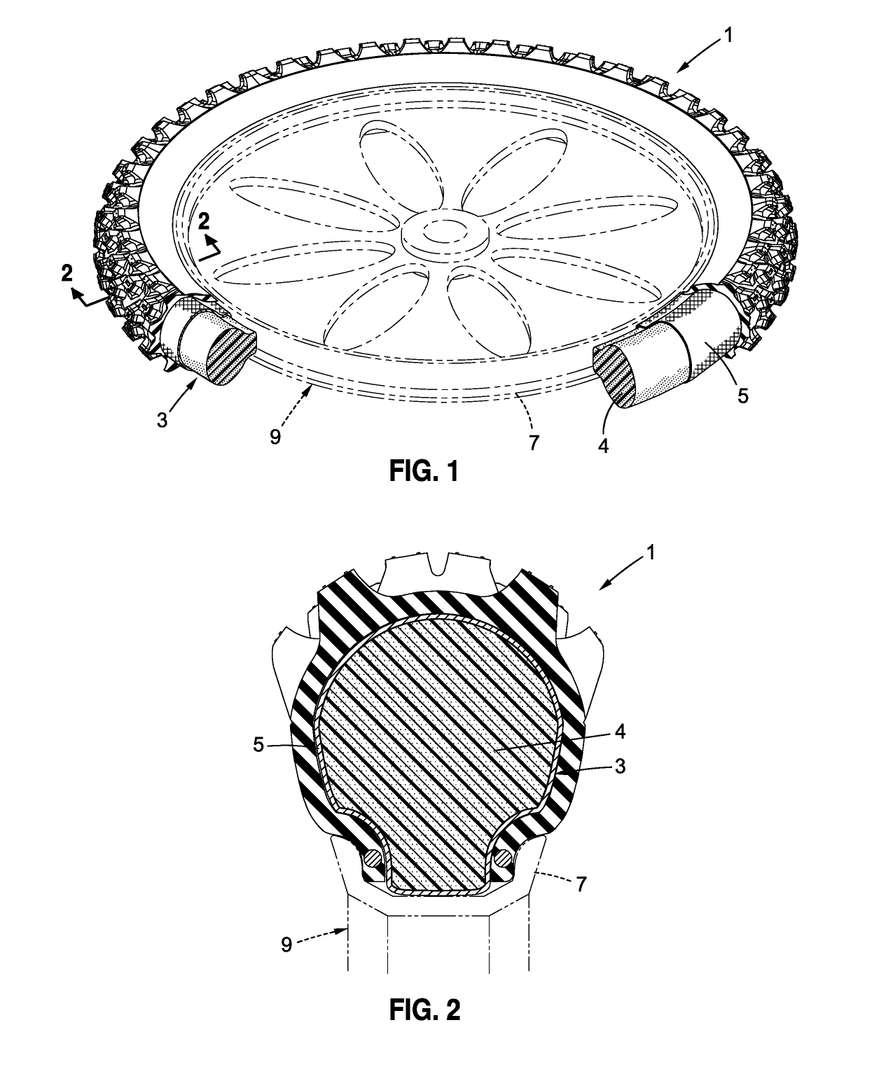

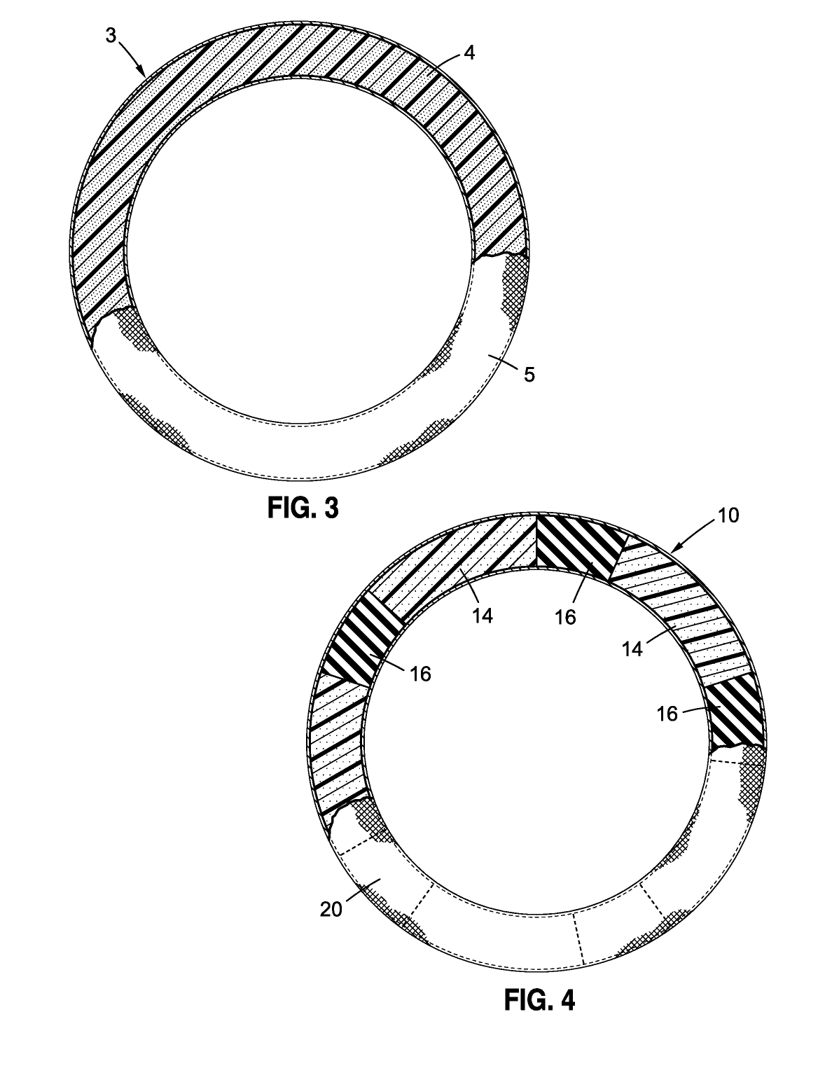

A first preferred embodiment for an improved combination flat-proof tire and low friction tire insert is described while referring to FIGS. 1-3 of the drawings. The tire 1 referred to herein is contemplated to be a conventional rubber tire that is mounted on the rim 7 of a conventional wheel (shown in broken lines and designated 9 in FIGS. 1 and 2) so as to be ideal for use on a motorcycle or any other suitable vehicle. The tire insert 3 includes a core 4 that is preferably manufactured (e.g., molded or extruded) from a solid resilient material so as to have an annular (i.e., donut) shape to completely fill and extend continuously around the interior of the tire 1. By way of example, the core 4 of insert 3 is manufactured from a flexible closed cell foam. The resilient core 4 that is located inside and completely around the tire 1 replaces a conventional pneumatic inner tube and advantageously provides the tire 1 with run flat support and the ability to continue to operate with a puncture. When the tire 1 is mounted on the wheel 9, the insert 3 will be seated on the rim 7.

In accordance with the improvement herein disclosed, the resilient core 4 of the tire insert 3 is surrounded by a low friction cover (i.e., a sleeve) 5. In particular, the low friction sleeve 5 is ideally manufactured from a smooth (e.g., textile) material (e.g., nylon) that is capable of reducing the usual surface-to-surface friction that is typically created between a conventional insert and a tire when the insert expands and contracts as a result of road conditions to which the tire is subjected.

In the tire 1 shown in FIGS. 1 and 2, the low friction sleeve 5 is not bonded or attached to the tire within which the insert 3 is located. Thus, the core 4 of tire insert 3 and the low friction sleeve 5 which surrounds the core are adapted to move independently of the tire 1 in response to forces that are transmitted through the tire to the insert 3. By virtue of the low friction sleeve 5 which surrounds the core 4, the heat that is encountered by the insert 3 is reduced compared to that typically generated within tires which include an insert but no friction reducing sleeve to cover and shield the insert as it moves through the tire.

Although the low friction cover for the tire insert 3 is shown in the drawings as being a single continuous sleeve 5, the cover may include a plurality of sleeves, one laying over the other. Each sleeve may surround part or all of the core 4. The number of sleeves and/or the thickness of each sleeve which surrounds the core 4 of insert 3 is determined by the dimensions of the tire 1 and the size of the core. However, for the purpose of avoiding failure (e.g., tears) when the tire is exposed to high impact forces, it has been found that the thickness of each sleeve 5 is preferably at least 0.005 inches.

Surrounding the core 4 with the low friction cover (i.e., sleeve) 5 herein disclosed increases the life of the insert and avoids the necessity for an early replacement thereof as might otherwise be required had the insert been uncovered or covered by a liquid lubricant or a powder which are prone to being rubbed off as a consequence of wear and time. The sleeve 5 may consist of a plurality of sections that are positioned over and around the core 4 of tire insert 3. In this case, one or more sections of the sleeve 5 can be removed from the insert 3 and replaced with a new section when needed. In the alternative, the sleeve can be a single piece that is wound or wrapped continuously around the core 4 and then sewn, bonded or sealed closed to create a cover lying thereover. In any case, the smooth low friction sleeve 5 is adapted to slide along the tire 1 as it rotates.

A second preferred embodiment for an improved combination flat-proof tire and low friction tire insert to be mounted on the rim of a wheel is described while referring to FIG. 4 of the drawings. In the embodiment shown in FIGS. 1-3, the core 4 of the insert 3 is manufactured from a single piece of foam or the like that conforms to the shape of and extends continuously around the inside of the tire 1. In the embodiment shown in FIG. 4, a generally annular, donut-shaped tire insert 10 is disclosed including a plurality of resilient insert segments 14 that are arranged in spaced side-by-side alignment with one another to extend completely around the inside of a tire and be seated on the rim thereof. The tire within which the insert segments 14 of insert 10 are located may be identical to the tire 1 shown in FIGS. 1 and 2.

A spacer 16 is located between each adjacent pair of the side-by-side aligned insert segments 14 of insert 10. Like the earlier described insert 3 of FIGS. 1-3, each resilient segment 14 of the insert 10 is preferably manufactured from a closed cell foam material. The alternating spacers 16 that separate the insert segments 14 from one another can be manufactured from either a relatively hard (e.g., plastic or rubber) or a relatively soft (e.g., foam) material. The number and size of the insert segments 14 and the spacers 16 which alternate with one another should not be regarded as a limitation of this invention and will depend upon the size of the tire within which the insert 10 will be located. The insert segments 14 and spacers 16 are laid in place one after another around the circumference of the tire. In the case where both the insert segments 14 and the spacers 16 are manufactured from foam, the density of the spacers 16 will be greater than the density of the insert segments 14.

By virtue of the plurality of spacers 16 that alternate with the resilient insert segments 14 within the insert 10 that extends completely and continuously around the inside of a tire, the insert segments 14 are able to move relative to and independently of one another around the tire. That is, the resilient insert segments 14 of the tire insert 10 can be compressed between opposing spacers 16 in response to road conditions. The compressive pressure to which the insert segments 14 will be subjected is dependent upon the density and hardness of the material from which the insert segments 14 and the spacers 16 are manufactured. The ability of the insert segments 14 of the tire insert 10 to be compressed and expand and move towards and away from one another around the tire enables the tire to be customized to correspondingly control the magnitude of the forces that will be transmitted from the tire to the (e.g., motorcycle) rider to selectively change his feel of the road through the tire while riding under different road conditions.

As in the case of the insert 3 which extends continuously around the tire 1 of FIGS. 1-3, the segmented tire insert 10 can be surrounded by a smooth low friction (e.g., nylon) cover (i.e., sleeve) 20. The sleeve 20 which surrounds the insert 10 holds the insert segments 14 and the spacers 16 in their side-by-side alignment. Moreover, the sleeve 20 minimizes the friction as well as the heat that would otherwise be created at the interface of the insert segments 14 and the tire as the segments are compressed and expanded so as to advantageously reduce the degradation of and the need to repair or replace the insert over time.

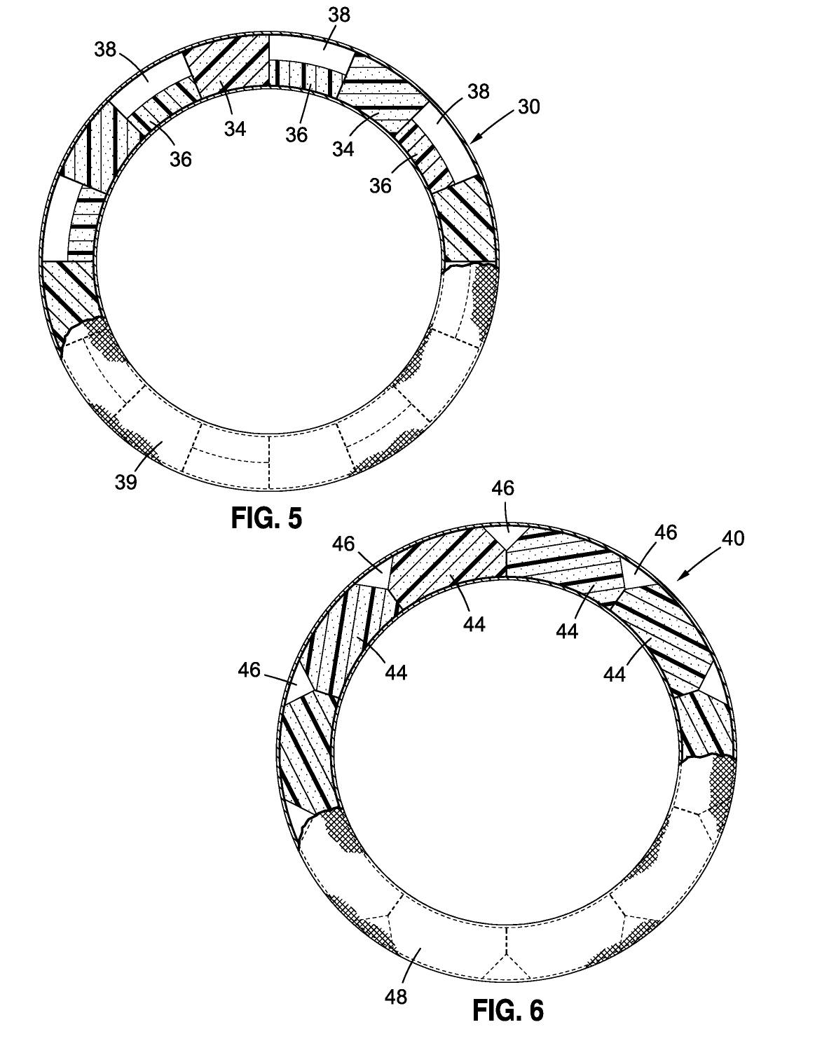

FIG. 5 of the drawings illustrates a modification to the low friction tire insert 10 shown in FIG. 4. Like the insert 10 of FIG. 4, the modified insert 30 of FIG. 5 has an annular or donut shape so as to extend continuously around a tire like that designated 1 and shown in FIGS. 1 and 2. Also like the previously described insert 10, the insert 30 includes a series of alternating resilient insert segments 34 and spacers 36. The insert segments 34 are preferably manufactured from foam or the like so as to be capable of undergoing compression and expansion to enable the insert 30 to move within the tire. The spacers 36 are manufactured from a material which has a hardness and/or a density that is greater than the hardness and/or density of the resilient insert segments 34.

The resilient insert segments 34 and the spacers 36 which alternate around the insert 30 are positioned side-by-side one another. By virtue of the foregoing, one or more of the insert segments 34 and spacers 36 can be relatively easily removed and replaced to facilitate repair of the insert 30. A void 38 or air gap is located above each spacer 36 of the insert 30. Each void 38 lies between the top of a spacer 36 and the crown of the tire. In the example of FIG. 5, the void 38 has a rectangular shape. The size and shape of the voids 38 correspondingly control the ability of the insert segments 34 to be compressed into the voids and move relative to one another. In this regard, the movement of resilient insert segments 34 can be localized within the tire to adjust the forces that will be felt by the rider through the tire. That is, the size of the spacers 36 and the voids 38 lying thereover can be selected so that the rider feels a relatively low pressure at the crown of the tire and a higher pressure at the tire side walls. This advantage will cause the tire in which the insert 30 is located to be less likely to roll or squirm when subjected to side loads in turns and corners.

The segmented tire insert 30 of FIG. 5 can be surrounded by a smooth low friction (e.g., nylon) cover (i.e., sleeve) 39 which may be substantially identical to the sleeves 5 and 20 that were described above. Therefore, the sleeve 39 covers the insert 30 and holds the insert segments 34 and spacers 36 in their side-by-side alignment. Likewise, the low friction sleeve 39 minimizes both the friction and heat that would otherwise be generated at the interface of the insert segments 34 and the tire, whereby to reduce the wear and degradation of the insert 30 over time.

A modification to the low friction insert shown in FIG. 5 is illustrated in FIG. 6 of the drawings. Like the insert 30 shown in FIG. 5, the modified tire insert 40 of FIG. 6 has an annular or donut shape so as to extend continuously around a tire like that designated 1 and shown in FIGS. 1 and 2. The insert 40 includes a plurality of identical resilient (e.g., foam) insert segments 44 that are aligned side-by-side one another and capable of compression and expansion in response to road forces so that the insert 40 can move relative to the tire in which it is located. Rather than the rectangular voids or air gaps 38 located above the spacers 36 shown in FIG. 5, a triangular (i.e., V-shaped) void or air gap 46 is created at the interface between each pair of adjacent insert segments 44. The triangular voids 46 are wider near the top of the insert segments 44 so as to lie opposite the crown of the tire. Accordingly, the greatest movement of the insert segments 44 will occur at the top of the segments which are compressed into the voids 46 to create a lower pressure and reduced force felt by the rider through the tire.

As in the case of the inserts 3, 10 and 30 of FIGS. 1-5, the segmented insert 40 can be surrounded by a smooth low friction (e.g., nylon) cover (i.e., sleeve) 48 to hold the insert segments 44 in their side-by-side alignment. The low friction sleeve 48 also minimizes both the friction and the heat that would otherwise be generated at the interface of the insert segments 44 and the tire, whereby to reduce the wear and degradation of the insert 40 over time.

1. A combination comprising:
a tire adapted to be mounted on a rim of a wheel of a vehicle; and
an insert that is located within the tire so that said insert fills and extends continuously around the tire, said insert having a friction reducing cover that lies at the interface of said insert and the tire so that said insert is movable within the tire.

2. The combination recited in claim 1, wherein said insert is manufactured from a resilient material so as to be compressed within the tire.

3. The combination recited in claim 2, wherein said resilient material is a closed cell foam.

4. The combination recited in claim 1, wherein said friction reducing cover is a sleeve that surrounds said insert.

5. The combination recited in claim 4, wherein said friction reducing sleeve is manufactured from a smooth textile material that is capable of reducing friction that is generated at the interface of the tire and said insert when said insert moves within the tire compared to the friction that would otherwise be generated at said interface without said insert being surrounded by said sleeve.

6. The combination recited in claim 5, wherein said smooth textile material is nylon.

7. A combination comprising:
a tire adapted to be mounted on a rim of a wheel of a vehicle; and
an insert that is located within the tire, said insert including a plurality of compressible insert segments that extend around the tire in side-by-side alignment and a plurality of spacers which alternate with said plurality of compressible insert segments around the tire, said compressible insert segments being compressed between adjacent pairs of said spacers in response to forces applied to said spacers from the tire so that said compressible insert segments move within the tire and relative to each other.

8. The combination recited in claim 7, wherein said plurality of spacers are manufactured from a material having a density that is greater than the density of the material from which said plurality of compressible insert segments are manufactured.

9. The combination recited in claim 7, wherein said insert also includes a friction reducing cover that lies on said plurality of compressible insert segments and said plurality of spacers, said friction reducing cover being located between said spacers and the tire.

10. The combination recited in claim 9, wherein the friction reducing cover of said insert is a sleeve that surrounds said plurality of compressible insert segments and said plurality of spacers and holds said insert segments and said spacers side-by-side one another.

11. The combination recited in claim 7, wherein there is a void located above each of said plurality of spacers and between each adjacent pair of said plurality of compressible insert segments, so that at least one of said compressible insert segments moves into at least one void in response to said plurality of insert segments being compressed.

12. The combination recited in claim 11, wherein the void located above each of said plurality of spaces and between each adjacent pair of compressible insert segments has a rectangular configuration.

13. A combination comprising:
a tire adapted to be mounted on a rim of a wheel of a vehicle; and
an insert that is located within the tire, said insert including a plurality of compressible insert segments that extend completely around the tire in side-by-side alignment with one another, said compressible insert segments being compressed in response to forces applied thereto from the tire so that said compressible insert segments move within the tire and relative to each other.

14. The combination recited in claim 13, wherein there is a void lying between each adjacent pair of said plurality of compressible insert segments so that at least one of said compressible insert segments moves into at least one void in response to said plurality of insert segments being compressed.

15. The combination recited in claim 14, wherein said void is shaped like a triangle which is wider at the top thereof than at the bottom, the wider tops of said triangular voids being positioned so as to face the tire.

16. The combination recited in claim 13, wherein said insert also includes a friction reducing cover that lies on said plurality of compressible insert segments, said friction reducing cover being located between said insert segments and the tire.

17. The combination recited in claim 16, wherein the friction reducing cover of said insert is a sleeve that surrounds said plurality of compressible insert segments and holds said insert segments in said side-by-side alignment.
